(19) United States
(12) Patent Application Publication
(10) Pub. No.: US 2018/0157495 A1
(43) Pub. Date: Jun. 7, 2018

(54) COMPUTER SYSTEM

(71) Applicants: Inventec (Pudong) Technology Corp., Shanghai (CN); Inventec Corporation, Taipei City (CN)

(72) Inventor: Ying-Xian Han, Shanghai (CN)

(21) Appl. No.: 15/486,867

(22) Filed: Apr. 13, 2017

(30) Foreign Application Priority Data
Dec. 2, 2016 (CN) 201611099423.9

(51) Int. Cl. G06F 9/44

(52) U.S. Cl. CPC G06F 9/4401

(57) ABSTRACT

The present disclosure provides a computer system, which includes a controlling unit and a memory. The controlling unit stores a first boot firmware, wherein the controlling unit has a first port. The memory is coupled to the first port of the controlling unit, wherein the memory stores a second boot firmware. When the computer is booted, the controlling unit detects the states of the first boot firmware and the second boot firmware, so as to select the first boot firmware or select to access the memory through the first port. Therefore, the working efficiency of the computer system is improved and the convenience of the usage is increased.

### CROSS REFERENCE TO RELATED APPLICATION

This application is based upon Chinese Patent Application 201611099423.9, filed Dec. 2, 2016, the entire contents of which are incorporated herein by reference.

### BACKGROUND

### Technical Field

The present disclosure is related to a computer technical field, and more particular to a computer system.

### Related Art

Currently, the motherboard of the computer may be equipped with the complex programmable logic device (CPLD) chip, so as to achieve the control of timing sequence for powering on or off the system and some settings of registers. Therefore, for the computer, the CPLD becomes very important. That is, once the timing sequence of the CPLD or the value of the register is wrong or confused, then the whole computer system may power off and does not work normally. Therefore, the firmware stored in the CPLD needs to restore, such that the computer system may resume the normal work.

However, when an accident occurs in the computer system and the firmware of the CPLD needs to restore, the user needs to install the corresponding software and buy a particular flat cable, and the restoring or updating of the firmware may fail easily, such that the work efficiency is affected seriously. Therefore, the computer system still needs to improve.

### SUMMARY

The main purpose of the present disclosure is to provide a computer system, thereby improving the working efficiency of the computer system and increasing the convenience of the usage.

In order to solve the above problem, an embodiment of the present disclosure provides a computer system, which includes a controlling unit and a memory. The controlling unit stores a first boot firmware, wherein the controlling unit has a first port. The memory is coupled to the first port of the controlling unit, wherein the memory stores a second boot firmware. When the computer is booted, the controlling unit detects the states of the first boot firmware and the second boot firmware, so as to select the first boot firmware or select to access the memory through the first port.

In one embodiment, if the controlling unit detects existence of the first boot firmware and the second boot firmware and the state of the first boot firmware is good, the controlling unit selects the first boot firmware.

In one embodiment, if the controlling unit selects the first boot firmware, the computer system executes the first boot firmware to boot.

In one embodiment, if the controlling unit detects existence of the first boot firmware and the second boot firmware and the state of the first boot firmware is invalid, the controlling unit selects to access the memory through the first port.

In one embodiment, if the controlling unit selects to access the memory through the first port, the computer system executes the second boot firmware to boot.

In one embodiment, the controlling unit further has a second port, and the computer system further includes a selecting unit, a joint test action group unit and a baseboard management controller. The selecting unit is coupled to the second port. The joint test action group unit is coupled to the selecting unit. The baseboard management controller is coupled to the selecting unit. Wherein the selecting unit selects the joint test action group unit or the baseboard management controller to couple to the second port, such that the compute system updates the first boot firmware through the joint test action group unit or the baseboard management controller.

In one embodiment, the memory is a serial peripheral interface read only memory, and the memory is coupled to the first port through a serial peripheral interface bus.

In one embodiment, controller unit is a complex programmable logic device.

According to the technical solution of the present disclosure, the controlling unit stores the first boot firmware and the memory stores the second boot firmware, such that the controlling unit may select the first boot firmware or select to access the second boot firmware of the memory according to the states of the first boot firmware and the second boot firmware, and then the computer system may use the first boot firmware or the second boot firmware to perform the boot operation. Therefore, the working efficiency of the computer system is improved and the convenience of the usage is increased.

### BRIEF DESCRIPTION OF THE DRAWINGS

The above and other exemplary aspects, features and advantages of certain exemplary embodiments of the present disclosure will be more apparent from the following description taken in conjunction with the accompanying drawings, in which:

FIG. 1 is a structure diagram of a computer system according to an embodiment of the present disclosure.

### DETAILED DESCRIPTION

The following description with reference to the accompanying drawings is provided to explain the exemplary embodiments of the present disclosure. Note that in the case of no conflict, the embodiments of the present disclosure and the features of the embodiments may be arbitrarily combined with each other.

The main idea of the present disclosure is that the controlling unit stores the first boot firmware and the memory stores the second boot firmware, such that the controlling unit may select the first boot firmware or select to access the second boot firmware of the memory according to the states of the first boot firmware and the second boot firmware, and then the computer system may use the first boot firmware or the second boot firmware to perform the boot operation. Therefore, the working efficiency of the computer system is improved and the convenience of the usage is increased.

According to an embodiment of the present disclosure, a computer system is provided.

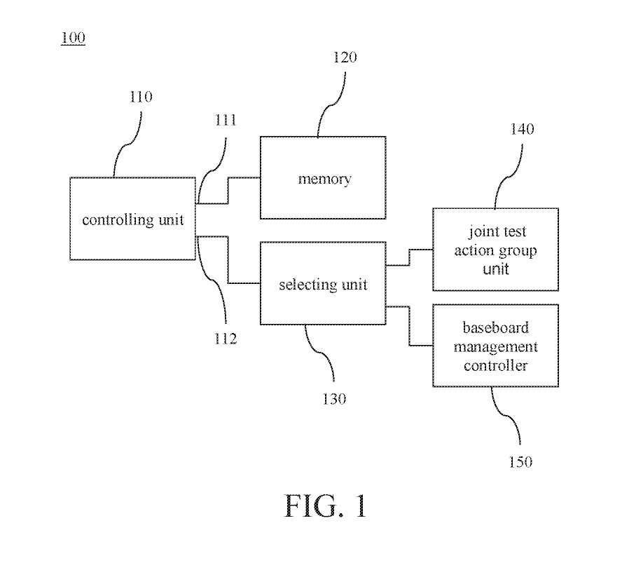

FIG. 1 is a structure diagram of a computer system 100 according to an embodiment of the present disclosure. The computer system 100 includes a controlling unit 110 and a memory 120.

The controlling unit 110 stores a first boot firmware, wherein the controlling unit has a first port 111. In the embodiment, the controlling unit 110 is, for example, a complex programmable logic device (CPLD), and the first port 111 is, for example, a serial peripheral interface (SPI).

The memory 120 is coupled to the first port 111 of the controlling unit 110, wherein the memory 120 stores a second boot firmware. In the embodiment, the memory 120 is, for example, a SPI read only memory (ROM), and the memory 120 is coupled to the first port 111 through a SPI bus. The first boot firmware and the second boot firmware are the firmware that the computer system 100 may perform the normal boot, and the versions of both may be identical or different.

When the computer system 100 is booted, the controlling unit 110 detects the states of the first boot firmware and the second boot firmware, so as to select the first boot firmware or select to access the memory 120 through the first port 111 for selecting the second boot firmware. That is, when the computer 100 is booted, the controlling unit 110 may select the first boot firmware or the second boot firmware, such that the computer system 100 executes the first boot firmware or the second boot firmware to perform the boot operation.

Further, if the controlling unit 110 detects existence of the first boot firmware and the second boot firmware and the state of the first boot firmware is good, the controlling unit 110 selects the first boot firmware. That is, the controlling unit 110 may preset the first boot firmware as the boot firmware which is selected preferentially, such that the controlling unit 110 detects that the state of the first boot firmware is good, and then selects the first boot firmware. If the controlling unit 110 selects the first boot firmware, the computer system 100 executes the first boot firmware to boot.

In the other hand, if the controlling unit 110 detects existence of the first boot firmware and the second boot firmware and the state of the first boot firmware is invalid, the controlling unit 110 selects to access the memory 120 through the first port 111. That is, the controlling unit 110 detects that the state of the first boot firmware is invalid, i.e. the first boot firmware may not be used as the boot firmware of the computer system 100, and the controlling unit 110 detects that the state of the second boot firmware is normal, the first controlling unit 110 access the memory 120 through the first port 111, so as to select the second boot firmware. If the controlling unit 110 selects to access the memory 120 through the first port 111, the computer system 100 executes the second boot firmware to boot.

According to the above content, the first boot firmware stored in the controlling unit 110 is a predetermined boot firmware, and the second boot firmware stored in the memory 120 is a secondary boot firmware. Therefore, when the state of the first boot firmware is invalid, the controlling unit 110 may select the second boot firmware stored in the memory 120, such that the computer system 100 executes the second boot firmware to boot, so as to ensure that the computer system 100 may work normally.

Additionally, in the embodiment, the controlling unit 110 further has a second port 112, wherein the second port 112 is, for example, a joint test action group (JTAG) port. The computer system 100 further includes a selecting unit 130, a joint test action group unit 140 and a baseboard management controller 150.

The selecting unit 130 is coupled to the second port 112. The joint test action group unit 140 is coupled to the selecting unit 130. The baseboard management controller 150 is coupled to the selecting unit 130. The selecting unit 130 selects the joint test action group unit 140 or the baseboard management controller 150 to couple to the second port 112, such that the compute system 100 updates the first boot firmware through the joint test action group unit 140 or the baseboard management controller 150.

That is, when the user needs to update the version of the first boot firmware, the new version of the first firmware may be stored in the joint test action group unit 140 or the baseboard management controller 150, such that when the controlling unit 110 controls the selecting unit 130 to couple to the joint test action group unit 140 or the baseboard management controller 150 and detects that the new version exists, the computer system 100 may use the new version to update the first boot firmware through the joint test action group unit 140 or the baseboard management controller 150.

Additionally, the second boot firmware stored in the memory 120 may be updated through the offline updating manner. Therefore, the convenience of the usage is increased.

In summary, according to the technical solution of the present disclosure, the controlling unit stores the first boot firmware and the memory stores the second boot firmware, such that the controlling unit may select the first boot firmware or select to access the second boot firmware of the memory according to the states of the first boot firmware and the second boot firmware, and then the computer system may use the first boot firmware or the second boot firmware to perform the boot operation. Therefore, the working efficiency of the computer system is improved and the convenience of the usage is increased.

Although the present disclosure is illustrated and described with reference to specific embodiments, those skilled in the art will understand that many variations and modifications are readily attainable without departing from the spirit and scope thereof as defined by the appended claims and their legal equivalents.

What is claimed is:

1. A computer system, comprising:
a controlling unit, storing a first boot firmware, wherein the controlling unit has a first port; and
a memory, coupling to the first port of the controlling unit, wherein the memory stores a second boot firmware;
wherein when the computer is booted, the controlling unit detects the states of the first boot firmware and the second boot firmware, so as to select the first boot firmware or select to access the memory through the first port.

2. The computer system according to claim 1, wherein if the controlling unit detects existence of the first boot firmware and the second boot firmware and the state of the first boot firmware is good, the controlling unit selects the first boot firmware.

3. The computer system according to claim 2, wherein if the controlling unit selects the first boot firmware, the computer system executes the first boot firmware to boot.

4. The computer system according to claim 1, wherein if the controlling unit detects existence of the first boot firmware and the second boot firmware and the state of the first boot firmware is invalid, the controlling unit selects to access the memory through the first port.

5. The computer system according to claim 4, wherein if the controlling unit selects to access the memory through the first port, the computer system executes the second boot firmware to boot.

6. The computer system according to claim 1, wherein the controlling unit further has a second port, and the computer system further comprises:
a selecting unit, coupling to the second port;
a joint test action group unit, coupling to the selecting unit; and
a baseboard management controller, coupling to the selecting unit;
wherein the selecting unit selects the joint test action group unit or the baseboard management controller to couple to the second port, such that the compute system updates the first boot firmware through the joint test action group unit or the baseboard management controller.

7. The computer system according to claim 1, wherein the memory is a serial peripheral interface read only memory, and the memory is coupled to the first port through a serial peripheral interface bus.

8. The computer system according to claim 1, wherein the controller unit is a complex programmable logic device.
